(19) United States
(12) Patent Application Publication
(10) Pub. No.: US 2026/0179140 A1
(43) Pub. Date: Jun. 25, 2026

(54) METHOD FOR GENERATING A CUSTOMIZED PORTFOLIO OF FINANCIAL PRODUCTS AND/OR SERVICES

(71) Applicant: WEALTHYPE S.P.A., Milano (IT)

(72) Inventors: Raffaele ZENTI, Milano (IT); Jacopo CARETTA MUSSA, Milano (IT); Michele ROTA BIASETTI, Ubiale Clanezzo (IT); Daniele D'AVINO, Domodossola (IT)

(21) Appl. No.: 18/711,619

(22) PCT Filed: Nov. 18, 2022
(86) PCT No.: PCT/IB2022/061142

§ 371 Date: May 20, 2024

(30) Foreign Application Priority Data
Nov. 18, 2021 (IT) 102021000029240

(51) Int. Cl. G06Q 40/00; G06Q 40/04

(52) U.S. Cl. CPC G06Q 40/00; G06Q 40/04

(57) ABSTRACT

A method for generating a personalized portfolio of financial products and/or services comprises: defining a first set of data containing information relating to financial products and/or services to be offered, collecting a plurality of data relating to the customer to whom to offer said products and/or services to define a second set of data, making up of a customer vector on the basis of the data of said second set, making up of a plurality of product/service vectors corresponding to each of the said first set, making up of a metric space comprising said customer vector and said product/service vectors, estimation of a distance between said customer vector and each of said product/service vectors to define a plurality of main indexes, definition of an output set comprising products and/or services for which said main index falls within a range of predetermined values range.

### TECHNICAL FIELD

The present invention finds application in the technical field of data processing and relates to a new method for generating a hyper-personalized portfolio of financial products and/or services based on data, Machine Learning and Data Science techniques.

### STATE OF THE ART

In the financial sector, and in particular for supplying financial products and services to the person, in particular to so-called “retail” customers, and of conventional financial planning, a traditional approach is still prevalent which requires the customer to request a service or product to a financial planner or advisor.

The latter, also according to the degree of knowledge of the products by the customer and his experience in the financial field, after having classified the customer according to a risk degree of, correlated both to the financial availability of the customer and to his risk attitude, offers a series of products and services on the basis of relatively standardized schemes.

The traditional approach to the overall management of an individual's assets and income statement is therefore rather static and operates through pre-set models, such as investment models, credit granting models, insurance and actuarial models, treasury models and the like, unrelated to each other.

Therefore, these are static models that are based on a representation of the final customer in terms of utility functions, risk aversion, time horizon, budget constraints. For example, US2021/0264520 discloses an intelligent system for the provision of context-specific personalized financial advice, which operates with a method that involves receiving a request for advice relating to a hierarchical portfolio of assets owned by the investor to generate suggestions for the modification of the hierarchical portfolio based on the output produced by a neural network-based machine learning model.

On the other hand, these models do not analyze the real needs of customers, their actual behaviors and sensitivities to various issues, or at least they do not do so in a holistic way considering the entire economic-patrimonial sphere of the customer.

The algorithmic construction of a portfolio of products and services for the client, and more generally the algorithm-assisted financial planning process, is mostly limited to investments, using models that derive from the Modern Portfolio Theory and its evolutions.

The scientific difficulty undermining decision support for customer life-cycle financial planning is twofold.

On the one hand, it is necessary to identify the real needs of customers, often represented by unexpressed needs and which in practice are typically carried out in a non-systematic/algorithmic way, based on the experience and sensitivity of those who manage the relationship with the customer; this is clearly inefficient and not scalable, in terms of process, and means that only a small portion of customers can be the subject of appropriate broad-spectrum financial advice, with obvious consequences in terms of financial inclusion.

Secondly, the need to employ tractable methods for the optimization of complex stochastic dynamical systems implies, in concrete terms, that such models are computationally limited to the consideration of a relatively small number of stylized stochastic market factors and on a limited number of goals.

By contrast, it is not considered that the customer could have a much wider range of targets whose costs require more frequent updates and more detailed models.

Nor are the practical details of real-world financial products considered, such as unit-linked policies, total return mutual funds, mortgages, pension funds, family insurance contracts, and so on.

Most real-world products are in fact “wrappers”, i.e. variable sets of different elementary financial and insurance products, many of which being actively managed (implying that their financial properties vary over time), and with which professional operators involved in financial advice have to deal with.

Furthermore, these models strongly depend on the extreme difficulty in producing reliable statistical estimates of the parameters linked to the dynamics of financial markets (with a low signal-to-noise ratio), which are notoriously very unstable and therefore difficult to predict.

It follows that the output is strongly influenced, with relative unreliability of the practice and poor quality of the final product, and more than anything else it turns out to have a commercial purpose.

Finally, these are models that are very far from the prosaic reality of final customers and the financial and insurance advisors who assist them.

### SCOPE OF THE INVENTION

The object of the present invention is to overcome the above drawbacks, providing a method for generating a personalized portfolio of financial products and/or services which allows for the generation of personalized recommendations for each specific customer in a particularly efficient manner and with use of relatively low resources, both in terms of time and costs.

A particular object is to provide a method for generating a personalized portfolio of financial products and/or services which is adapted to provide each customer, as conditions and the economic-financial environment vary, with a specific portfolio of customized products and services, using the complete range of financial products and services, such as investments, insurance products, loans, payment instruments and the like, available from each intermediary.

A particular object is to provide a method for generating a customized portfolio of financial products and/or services that is scalable and suitable to individually meet the financial needs of real people and their advisors starting from data referred thereto, resulting in a completely true-to-life relationship.

Still another particular object is to provide a method for generating a personalized financial portfolio of products and/or services which allows to obtain advantages both of a technical nature, such as automatic personalization and improvement of the quality of the outputs, through the adaptive capacity of the system to individual conditions, and of economic nature, through the generation of higher sales volumes and revenues, due to the scalability of the process, and the greater customer loyalty, with a consequent increase in the life-time value associated with each customer.

This also results in an improvement in the individual productivity of the operator who manages the relationship with the customer as well as a generalized improvement in the effectiveness and efficiency of the process.

These objects, as well as others which will become more apparent hereinafter, are achieved by a method according to claim 1, to which reference is made for greater conciseness of the exposition.

Advantageous embodiments of the invention are obtained according to the dependent claims.

### BRIEF DISCLOSURE OF THE DRAWINGS

Further features and advantages of the invention will become more apparent in the light of the detailed description of preferred but not exclusive embodiments of the method according to the invention, illustrated by way of non-limiting example with the aid of the attached drawing table wherein:

FIG. 1 is a possible operating scheme according to the method.

### BEST MODES OF CARRYING OUT THE INVENTION

The method according to the present invention has as its main object the generation of hyper-personalized recommendations relative to financial services and products, based on data, Machine Learning and Data Science techniques starting from input data relating both to the specific customer and data referable to customer profiles already acquired in order to create a dynamic database.

Further input data will then refer to the products and/or services of a financial nature that may potentially be offered to the customer to define the final portfolio on the basis of which to produce recommendations to the specific customer, which may possibly also deviate from the generated portfolio also in function of the sensitivity and experience of the consultant.

The portfolio will consist of financial products and services, such as investments, insurance, loans, payment instruments, designed to improve the customer's financial well-being by maximizing a well-being index (Financial Wellness Index).

This well-being index will be correlated to the specific needs of the individual customer, adapting to his consumer profile and his behavior, also suggesting the most suitable communication methods.

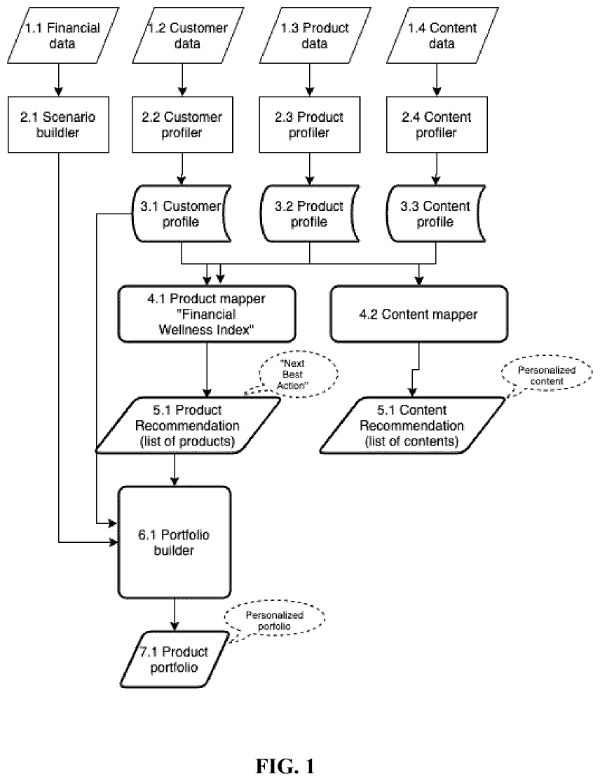

As schematized in FIG. 1, according to a typical operating method, preferred but not exclusive, the method first of all provides that, having defined a first set of data containing information relating to financial products and/or services that can potentially be offered to a customer, one proceeds with a collection of a plurality of data relating to the customer to whom said products and/or services may be proposed to define a second set of data.

The data that will make up the second set may initially also be in small quantities and possibly insufficient to allow an optimal association between the customer and the product/service portfolio.

In this case, it will be possible to provide a step of increasing and enrich the data contained in the second set through the use of AI and/or Machine Learning algorithms. Once the two sets of data have been defined, we will proceed with the construction of a customer vector on the basis of the data of the second set and with the construction of a plurality of product/service vectors corresponding to each of the data of the first set.

All the above steps will allow the construction of a metric space within which the distance between the customer vector and each of the product/service vectors will be estimated.

In this way, each of the products and/or services will be associated with a respective main index, i.e. the above well-being index, which will allow the definition of an output set including products and/or services for which this main index falls within a predetermined range of values.

The set of outputs may correspond to the portfolio of products and/or services of a financial nature to be recommended to the customer, or may serve the financial advisor as a basis for creating this portfolio.

For example, the output set may consist of all the products and/or services whose main index will be higher than a predetermined value, or it may correspond to the set of products and/or services having the main index of the maximum value.

The main index can be calculated as a function of the distance between the customer vector and the corresponding product/service vector.

In an exemplifying but non-limiting form, the main index may be inversely proportional to this distance.

However, it will be possible to use additional calculation functions which may be selected, also on the basis of the type of customer, from a series of predefined functions and which may comprise, again by way of example and not as a limitation, the application of specific weights to each product/service, and therefore to the relative distance, or, again, the use of boolean type criteria.

Preferably, the construction of the customer and product/service vectors will be obtained as an estimate of the respective values through the use of Machine Learning and/or Data Science techniques.

At the same time, it will also be possible to provide the implementation of manual estimation techniques.

In addition to the financial products and services that will define the output set and on which the portfolio containing the recommended products/services will be based, it will also be possible to define a third data set that comprises a plurality of products and/or auxiliary services.

In particular, such auxiliary products/services may be customer support content, such as digital, paper, financial education, commercial value, which, while not representing a product or service of a financial nature, are aid to the customer for the management of the portfolio or to support the choice of products/services.

In this case we will proceed to the construction of a plurality of contents vectors corresponding to each of the data of the third set and to a subsequent step of estimating the distance between the client vector and each of the contents vectors to define a plurality of secondary indexes.

In this way, a second set of outputs will be defined comprising products and/or auxiliary services for which the secondary index falls within a predetermined range of values, i.e. it is higher than a predefined minimum value.

Alternatively, it will be possible to provide a single index that takes into account both distances.

The method thus implemented is therefore shown to be a dynamic and adaptive method, as it adapts to the current situation of the customer as new data become available.

The method is designed as a robo-advisory type method, if used with a direct channel, i.e. B2C, or a robo-for-advisory method, if used with the intermediation of financial advisors, private bankers, insurance agents, i.e. B2B2C.

The method according to the invention makes it possible to overcome the limitations of traditional methods for which such marked attention to the needs of each customer, if implemented manually by those who manage the relationship with the customer, i.e. without the support of Machine Learning, would be expensive both in terms of costs and time.

Furthermore, the indiscriminate use of Machine Learning is avoided, which would have a high probability of generating spurious results (“overfitting”), which are difficult to interpret (“black-box” problem), neglecting financial best practice.

On the contrary, the method according to the present invention, based on Bayesian Machine Learning, makes it possible to incorporate best practice information into a Machine Learning process, making the process automatic, industrial and scalable, with gains in efficiency, productivity and profitability, since allows you to serve a much larger customer base.

1. A method for generating a customized portfolio of financial products and/or services, comprising the following steps:
a) definition of a first set of data containing information relating to financial products and/or services to be offered to a customer;
b) collection of a plurality of data relating to the customer to whom said products and/or services has to be offered to define a second set of data;
c) definition of a set of outputs comprising products and/or services suitable for defining the customized portfolio;
d) making up of a client vector based on the data of said second set of data;
e) making up of a plurality of product/service vectors corresponding to each of the data of said first set of data;
f) making up of a metric space comprising said client vector and said plurality of product/service vectors;
g) estimation of a distance between said client vector and each product/service vector of said plurality of product/service vectors to define a plurality of main indexes;
wherein said set of outputs is defined by the products and/or services for which said main index falls within a predetermined range of values.

2. The method as claimed in claim 1, wherein said construction steps of said client vector and said plurality of product/service vectors are obtained as an estimate of the respective values by using Machine Learing and/or Data Science techniques.

3. The method as claimed in claim 1, wherein Bayesian Machine Learning techniques are used.

4. The method as claimed in claim 1, wherein a step is provided for increasing the data contained in said second set of data by using AI and/or Machine Learning algorithms.

5. The method as claimed in claim 1, wherein said set of outputs is made up by the products and/or services corresponding to main indexes having a value higher than a predetermined value.

6. The method as claimed in claim 1, wherein a step is provided for defining a third data set which comprises a plurality of auxiliary products and/or services.

7. The method as claimed in claim 6, wherein a step is provided for the construction of a plurality of contents vectors corresponding to each of the data of said third data set and a subsequent step of evaluating a distance between said client vector and each of said contents vectors to define a plurality of secondary indexes.

8. The method as claimed in claim 7, wherein a step is provided for defining a second set of outputs comprising auxiliary products and/or services for which the respective secondary index of said plurality of secondary indexes falls within a predetermined range of values.
